(19) United States
(12) Patent Application Publication
(10) Pub. No.: US 2025/0264166 A1
(43) Pub. Date: Aug. 21, 2025

(54) PIPE SUPPORT

(71) Applicant: Polyflow LLC, Midland, TX (US)

(72) Inventors: Jeffrey Kenneth Shorter, Magnolia, TX (US); Liang Yu, Katy, TX (US)

(21) Appl. No.: 18/442,652

(22) Filed: Feb. 15, 2024

(51) Int. Cl. E21B 19/10; F16L 1/036; F16L 1/06

(52) U.S. Cl. CPC F16L 1/036; F16L 1/06; E21B 19/22

(57) ABSTRACT

A method and apparatus for supporting a segment of reinforced thermoplastic pipe (RTP) are disclosed. The method comprises providing an end region of a segment of RTP body and as clamping elements of a clamp disposed around a covered portion of the end region are urged together to thereby support the end region at a fixed orientation, simultaneously opposing radially inwards collapse of at least one layer of the RTP body in the covered portion via a collapse resistant body disposed in a bore region of the covered portion.

### FIELD

Embodiments disclosed herein relate to a method and apparatus for supporting a pipe. For example and without limitation, embodiments disclosed herein relate to locating a brace in the bore of a segment of Reinforced Thermoplastic Pipe (RTP) and carrying out a clamping step at the location of the brace to reduce risk of collapse of the segment of RTP. This can be carried out whilst attaching a further segment of RTP to the clamped segment in an end to end configuration. The brace can subsequently be removed and fluid thereafter transported via the connected RTP.

### BACKGROUND

From time to time, hydrocarbons are extracted from an underground reservoir using a wellbore during a so-called production phase of oil and gas exploration. A well (e.g., an oil well) is formed and hydrocarbons are transported to a wellhead using production tubing. Over time as hydrocarbons are extracted from the reservoir, reservoir pressure may decrease such that there is insufficient velocity to transport fluids from the reservoir to the wellhead. In such situations, a velocity string may be utilised to maintain operation of the well. It will be appreciated that a velocity string is usually a small diameter pipe, approximately, but not exclusively, 1-8 inches (25.4 mm-203.2 mm) in diameter, placed inside of and/or generally concentric to a bore of production casing. The velocity string may reduce a cross section of the bore of the production casing, increasing a velocity of fluid passing through the pipe and thereby facilitating the continued flow of hydrocarbons from the reservoir.

Sometimes reinforced thermoplastic pipe (RTP) is used as a velocity string, for example, during a non-metallic downhole velocity string deployment process. RTP may also be used as downhole tubing, horizontal tubing, in mining applications, or the like. In any case, there is a necessity to hold the RTP temporarily for installing couplings joining the next segment of RTP.

RTP may either be of an unbonded construction, where the layers of RTP body are unbonded to each other, i.e. the inner fluid containing polymer liner layer is not bonded to the reinforcement layer, which is in turn not bonded to the outer protective sheath polymer layer, or of a bonded construction, i.e. all layers are bonded to each other as part of the pipe manufacturing resulting in a pipe which is in effect a single, consolidated layer comprising sub-layers. RTP of either type may be suitable for use in transporting and/or distributing oilfield fluids, such as water, gas (methane, ethane, CO₂ etc.) and/or the transport and distribution of hydrocarbon liquids, or other fluids such as hydrogen may be used onshore (over land) or in very shallow water applications (for instance less than 50 m water depth). That is to say RTP may be for transporting production fluids.

Structurally, multilayer RTP may have a non-complex construction, often comprising two or more polymer layers each of which may be similar or different polymer types. The American Petroleum Institute Specification 15S is a reference for an example of these types of pipes. The inner and outer polymer layers (often termed as liner and protective sheath respectively) are extruded polymers of at least one type of polymer. In certain embodiments for some applications the inner polymer layer may comprise sub-layers similar or different polymer compositions which are co-extruded to form a liner.

At certain stages associated with installation and use of pipe one or more regions of an RTP should be supported temporarily or permanently at a desired position. A way to do this is via an external clamp. A clamp in this context is a multi component element that permits parts to be urged together to grasp the outer surface of an RTP. When an external clamp is put on non-metallic downhole tubing such as RTP to hold it at a well head, the maximum capacity that the clamp has is often governed by the frictional load transfer between the pipe's outer sheath layer and the reinforcement layer underneath. The governing failure mode during clamping is often the tear of the polymeric cover layer, which occurs at a relatively low load compared to the whole RTP axial tension strength including contributions from the reinforcement layers.

Simply increasing the clamping pressure does not solve the issue because RTP can have low radial strength and stiffness. High clamping pressure will thus result in deforming and even crushing RTP body. The pipe is prone to partial or complete collapse under clamping pressure.

### SUMMARY

It is an aim of certain embodiments disclosed herein to at least partly mitigate one or more of the above-mentioned problems.

It is an aim of certain embodiments disclosed herein to support flexible pipe such as RTP body during clamping.

It is an aim of certain embodiments disclosed herein to support RTP body during clamping whilst being readily removable afterwards without thereafter blocking or breaching RTP body.

It is an aim of certain embodiments disclosed herein to help reduce failure of RTP body when supporting RTP body.

It is an aim of certain embodiments disclosed herein to help locate a brace member in a bore of RTP body.

It is an aim of certain embodiments disclosed herein to provide apparatus for helping prevent collapse of a segment of RTP body due to an external clamping force acting in a radially inwards direction.

It is an aim of certain embodiments disclosed herein to provide apparatus for helping prevent tearing of the outer sheath of a segment of RTP body due to axial stress caused by a friction force exerted on the outer sheath as a result of weight of suspended segments of RTP body.

It is an aim of certain embodiments disclosed herein to provide a method for facilitating the installation of couplings joining segments of suspended RTP.

It is an aim of certain embodiments disclosed herein to provide a method for facilitating joining segments of RTP body whilst the segments are suspended during downhole deployment without requiring new equipment for clamping, supporting, and/or tensioning the segments of RTP body.

It is an aim of certain embodiments disclosed herein to facilitate extension of an RTP during downhole deployment.

According to a first aspect there is provided a method of supporting an end region of a reinforced thermoplastic pipe (RTP), comprising: providing an end region of a segment of RTP body; and as clamping elements of a clamp disposed around a covered portion of the end region are urged together to thereby support the end region at a fixed orientation, simultaneously opposing radially inwards collapse of at least one layer of the RTP body in the covered portion via a collapse resistant body disposed in a bore region of the covered portion.

In certain embodiments, the collapse resistant body comprises at least one cylindrical outer surface region and opposing radially inward collapse comprises resisting radially inwards motion of at least an inner surface of an inner layer of the RTP body via abutment of said inner surface against said cylindrical outer surface region.

In certain embodiments, subsequent to supporting the end region at a desired position via the clamping elements, securing a coupling element at a free end of the end region and securing a respective free end of a further segment of RTP body, in an end-to-end configuration with said a segment; and subsequently at least partially removing the collapse resistant body from said a bore region.

In certain embodiments, providing the collapse resistant body by cooling a zone of the RTP body thereby freezing a region of stationary liquid located in the bore region to form a frozen brace member; and opposing radially inward collapse via resisting radially inwards motion of at least an inner surface of an inner layer of the RTP body via abutment of said inner surface against an outer surface region of the frozen brace member.

In certain embodiments, providing the collapse resistant body by inflating a flexible hollow body via urging fluid into a chamber in the flexible hollow body to at least a predetermined internal pressure to form an inflated brace member; and opposing radially inward collapse via resisting radially inwards motion of at least an inner surface of an inner layer of the RTP body via abutment of said inner surface against an outer surface region of the inflated brace member.

In certain embodiments, providing the collapse resistant body by hardening a gel body via urging liquid gel into a mould or inflatable shell and enabling a chemical reaction to take place to form a gel hardened brace member; and opposing radially inward collapse via resisting radially inwards motion of at least an inner surface of an inner layer of the RTP body via abutment of said inner surface against an outer surface region of a gel hardened brace member provided via hardening a gel body via urging liquid gel into a mould and enabling a chemical reaction to take place to form the gel hardened brace member.

In certain embodiments, subsequent to securing said a segment of RTP body to a further segment of RTP body via at least one coupling element, at least partially removing said collapse resistant body by dissolving the gel hardened brace member.

In certain embodiments, subsequent to securing said a segment of RTP body to a further segment of RTP body via at least one coupling element, at least partially removing said collapse resistant body by melting the frozen brace member.

In certain embodiments, subsequent to securing said a segment of RTP body to a further segment of RTP body via at least one coupling element, at least partially removing said collapse resistant body by deflating the inflated brace member.

In certain embodiments, securing the coupling element further comprises: terminating a precursor end region of the segment of RTP body, thereby providing the free end of the end region; and swaging the free end into the coupling element.

In certain embodiments, prior to urging together clamping elements of the clamp, positioning the collapse resistant body in the bore region at a location associated with the covered portion.

In certain embodiments, inserting the collapse body into the bore region via the free end of the end region of the RTP body or via a free end of a further end region of the RTP body or via an opening in the RTP body.

In certain embodiments, positioning the collapse resistant body further comprises: providing, at least one indicator for a location of the collapse resistant body in the bore region; and subsequently detecting an indicator associated with the location of the collapse resistant body thereby determining a current location of the collapse resistant body in the bore region.

According to a second aspect there is provided apparatus for resisting collapse of a portion of reinforced thermoplastic pipe (RTP) body, comprising: a collapse resistant body that comprises a first end and a further end disposed in a spaced apart relationship with the first end with a whole length of the collapse resistant body being at least 15 cm and a substantially cylindrical outer surface that extends over at least 70% of the whole length, the collapse resistant body providing an effective rigidity in a cylindrical region of the collapse resistant body where the outer surface is substantially cylindrical providing an effective hardness of the collapse resistant body in the cylindrical region of at least 50 on the Rockwell R scale and the collapse resistant body has a radial compression resistance at least able to withstand a radial clamping force sufficient for a resulting friction force on a test piece to resist a tension force of 70 kN (kilo newtons) applied along a longitudinal axis of the test piece.

In certain embodiments, the collapse resistant body comprises a solid body or the body comprises a hollow tube body.

In certain embodiments, the solid body or hollow tube body are provided as an integrally formed body of at least one material.

In certain embodiments, the solid body or hollow tube body comprises: an inflatable shell defining an internal chamber region; and at least one fluid port.

In certain embodiments, the inflatable shell comprises a further solid body in the internal chamber region.

In certain embodiments, the solid body further comprises a first end plate at the first end and a further end plate at the further end where each of the first end plate and the further end plate are connected to at least one supporting member at respective ends of said at least one supporting member.

In certain embodiments, the collapse resistant body is locatable in a bore region of RTP body, wherein at least one external dimension of the collapse resistant body is reducible through a change in an internal and/or external condition.

In certain embodiments, at least one externally discoverable element that is detectible outside of the RTP body when the collapse resistant body is located in a bore region of the RTP body.

In certain embodiments, said radial clamping force is provided by a clamp at a covered portion of an outer surface of the test piece and a bore of the test piece is supported by the collapse resistant body located in the bore at the covered portion.

In certain embodiments, the resulting friction force is provided by the radial clamping force exerted by the clamp on the outer surface of the test piece and the clamp is provided at a predetermined relative position to a loading framework as defined in ISO 3501 and optionally the clamp is provided at the predetermined relative position via abutment or mounting to the loading framework.

According to a third aspect there is provided apparatus for supporting a segment of an RTP, comprising: a segment of RTP body comprising an internal bore, an inner layer, a reinforcement layer and an outer layer; a clamp locatable around the outer layer; and a collapse resistant body comprising a first end and a further end disposed in a spaced apart relationship with the first end with a whole length of the collapse resistant body being at least 15 cm and a substantially cylindrical outer surface that extends over at least 70% of the whole length, the collapse resistant body providing an effective rigidity in a cylindrical region of the collapse resistant body where the outer surface is substantially cylindrical providing an effective hardness of the collapse resistant body in the cylindrical region of at least 50 on the Rockwell R scale and the collapse resistant body has a radial compression resistance at least able to withstand a radial clamping force sufficient for a resulting friction force on a test piece to resist a tension force of 70 kN (kilo newtons) applied along a longitudinal axis of the test piece, wherein the collapse resistant body is for opposing radially inward collapse via resisting radially inwards motion of at least an inner surface of the inner layer of the RTP body via abutment of said inner surface against an outer surface region of the collapse resistant body.

In certain embodiments, said radial clamping force is provided by a clamp at a covered portion of an outer surface of the test piece and a bore of the test piece is supported by the collapse resistant body located in the bore at the covered portion.

In certain embodiments, the resulting friction force is provided by the radial clamping force exerted by the clamp on the outer surface of the test piece and the clamp is provided at a predetermined relative position to a loading framework as defined in ISO 3501 and optionally the clamp is provided at the predetermined relative position via abutment or mounting to the loading framework.

In certain embodiments, an RTP is a subset of a flexible pipe.

In certain embodiments, RTP body is a subset of flexible pipe body.

According to a fourth aspect there is provided a method of supporting an end region of a pipe, comprising the steps of: providing an end region of a segment of pipe body; and as clamping elements of a clamp disposed around a covered portion of the end region are urged together to thereby support the end region at a fixed orientation, simultaneously opposing radially inwards collapse of at least one layer of the pipe in the covered portion via a collapse resistant body disposed in a bore region of the covered portion.

Certain embodiments provide apparatus that fully or partially opposes a radially inwards collapse of RTP body.

Certain embodiments provide apparatus that increases crush resistance of RTP body when required.

Certain embodiments provide a method that facilitates supporting suspended RTP whilst avoiding failure of that RTP.

Certain embodiments provide a method that locates one or more brace members in a bore of an RTP.

Certain embodiments provide a method for forming a brace member in a bore of an RTP on-site.

Certain embodiments provide a method for supporting one or more segments of RTP body suspended by a clamp.

Certain embodiments provide a method for supporting one or more suspended segments of RTP body gripped on an outer sheath of RTP body whilst helping to prevent tearing of the outer sheath caused by axial stress exerted on the outer sheath provided by self-weight of the suspended segments.

Certain embodiments provide a method for joining separate segments of RTP body together whilst suspended.

Certain embodiments provide an increase in load transfer efficiency between an outer sheath of RTP and a reinforcement layer of RTP.

Certain embodiments provide apparatus that can be temporarily installed in a segment of RTP body in at least part of a covered portion of a bore and later removed to prevent inhibition of fluid flow through the bore without access to an end of the segment.

Certain embodiments provide apparatus that enables non-metallic downhole tubing to be deployed in wells with larger depth whilst requiring minimum modification to a common coil tubing unit and BOP operation.

Certain embodiments of the present invention provide a methodology and apparatus for supporting flexible pipe body at a desired location permanently or temporarily without risk of total or partial collapse of the pipe body that would otherwise cause a bore to close and thus transportation of fluids to be hindered. For permanent support a brace that resists collapse can have a through bore which provides a fluid communication passageway through a body of the brace. For temporary support the brace can temporarily occlude through flow of fluid along a bore of flexible pipe body until clamping has been terminated. Thereafter the brace can be removed via an appropriate removal step.

Certain embodiments provide a method for supporting segments of RTP body in a way that is technically simple, reliable and can reduce deployment time.

Certain embodiments provide a method for locating apparatus near couplings for supporting a bore of RTP from inwards collapse and for subsequently removing said apparatus from the bore from the near-centre of the coupled RTP.

### BRIEF DESCRIPTION OF THE DRAWINGS

Some embodiments of the present disclosure will now be described hereinafter, by way of example only, with reference to the accompanying drawings in which:

FIG. 1 illustrates a section view of RTP body;

FIG. 2 illustrates a cross-section view of an onshore assembly in a well;

FIG. 3 illustrates a cross-section view of RTP body;

FIG. 4 illustrates in cross-section how an end of an RTP may be supported;

FIG. 5A illustrates a frozen brace member;

FIG. 5B illustrates a possible test configuration;

FIG. 6 illustrates how a frozen brace member can be formed;

FIG. 7 illustrates pipe deployment;

FIG. 8 illustrates forming a frozen brace member in RTP body bore;

FIGS. 9A and 9B illustrate clamping a section of RTP body;

FIG. 10 illustrates installing a coupling onto a section of RTP body;

FIG. 11 illustrates joining two RTPs;

FIG. 12 illustrates recontinuation of pipe deployment;

FIG. 13 illustrates an inflatable brace member;

FIG. 14 illustrates an alternative inflatable brace member;

FIG. 15 illustrates a gel-formed brace member; and

FIG. 16 illustrates a dissolvable brace member.

In the drawings like reference numerals refer to like parts.

### DETAILED DESCRIPTION

Throughout this description, reference will be made to a type of flexible pipe known as reinforced thermoplastic pipe (RTP). It will be appreciated that RTP manufactured according to American Petroleum Institute (API) standard 15S may be used at least in part herein. Optionally RTP manufactured according to API 15S may be used interchangeably with RTP 280 and/or RTP body 100 manufactured to any other standard, or to no standard, as disclosed herein. It is to be appreciated that certain embodiments may also be applicable to use with a wide variety of flexible pipe. For example, certain embodiments can also be used with respect to flexible pipe body and associated end fittings of the type which is manufactured according to API 17J. Such flexible pipe is often referred to as unbonded flexible pipe. Other small, medium or large bore flexible pipes might be usable. Such pipes may have an internal through bore which provides a passageway along which fluid can be conveyed, an outer sheath that includes an outer surface that provides a clamping surface and one or more internal layers.

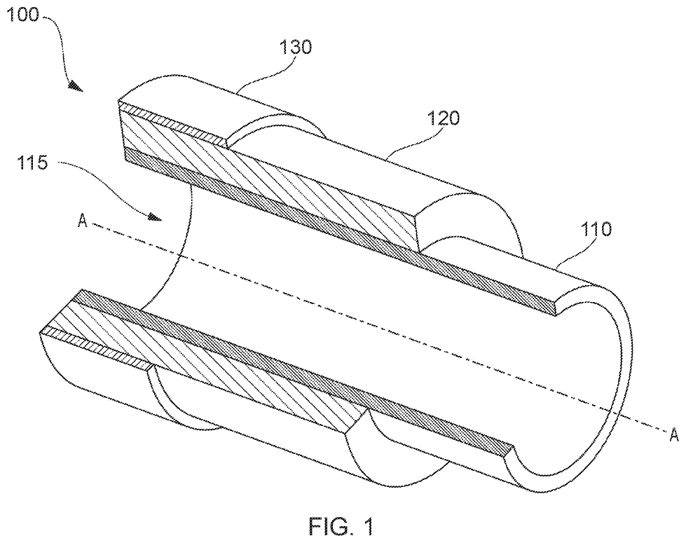

It will be understood that the illustrated RTPs are an assembly of a portion of RTP body and one or more splice couplings (not shown) in each of which a respective end of RTP body is terminated. FIG. 1 illustrates how pipe body 100 is formed from a combination of layered materials that form a pressure-containing conduit according to a first embodiment. RTP body 100 has a central axis marked by A-A in FIG. 1. As noted above, although a number of particular layers are illustrated in FIG. 1, it is to be understood that certain embodiments are broadly applicable to coaxial pipe body structures including two or more layers manufactured from a variety of possible materials. Pipe body 100 may include one or more layers comprising composite materials, forming a tubular composite layer. It is to be further noted that the layer thicknesses are shown for illustrative purposes only. As used herein, the term “composite” is used to broadly refer to a material that is formed from two or more different materials, for example a material formed from a matrix material and reinforcement fibres. Pipe body may include one or more layers of a single material, forming a tubular uniform layer.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process or, by a winding process in which adjacent windings of tape which themselves have a composite structure are bonded together with adjacent windings.

The bonded composite layers are thus consolidated. The composite material, regardless of manufacturing technique used, may optionally include a matrix or body of material having a first characteristic in which further elements having different physical characteristics are embedded. That is to say elongate fibres which are aligned to some extent and/or smaller fibres randomly orientated can be set into a main body, or spheres or other regular or irregular shaped particles can be embedded in a matrix material, or a combination of more than one of the above. In certain embodiments, the matrix material is a thermoplastic material. In certain embodiments, the thermoplastic material is polyethylene or polypropylene or nylon or PPS or PVC or PVDF or PFA or PEEK or PTFE, alloys of such materials, or alloys of such materials with reinforcing fibres manufactured from one or more of ceramic, carbon, carbon nanotubes, aramid, steel, nickel alloy, titanium alloy, aluminium alloy or the like or fillers manufactured from ceramic, carbon, metals, buckminsterfullerenes, metal silicates, carbides, carbonates, oxides or the like.

The embodiment of RTP body 100 illustrated in FIG. 1 includes a fluid (i.e., liquid or gas) retaining layer 110 which is non-porous. In certain embodiments, the fluid retaining layer 110 is tubular in shape. The fluid retaining layer 110 is a polymer layer that ensures internal fluid containment. The layer can provide a boundary for any conveyed fluid. It is to be understood that the fluid retaining layer 110 may itself comprise a number of sub-layers in some embodiments.

The fluid retaining layer 110 is made of high-density polyethylene (HDPE). It will be appreciated that in other embodiments, the fluid retaining layer 110 may be made of a different polymer. It will be appreciated that in some embodiments, the fluid retaining layer 110 may consist of any polyethylene, polyethylene raised temperature, polypropylene, a polyamide, or polyvinylidene difluoride (PVDF). The fluid retaining layer 110 in FIG. 1 is formed by an extrusion process, although it will be appreciated by a person skilled in the art that the fluid retaining layer may be manufactured in other ways. The fluid retaining layer 110 is the innermost layer of RTP body 100 and thus defines a pipe bore 115 of RTP body. In certain embodiments, the internal diameter of the fluid retaining layer-which may also be referred to as the bore 115—may be between 2 inches (50.8 mm) and 6 inches (152.4 mm), but preferably within the range of 3 inches (76.2 mm) and 4 inches (101.6 mm). It will be appreciated that in other embodiments the pipe bore 115 may be larger or smaller in diameter. In certain embodiments, the bore fluid is constrained to being within the bore 115 of RTP body 100.

The embodiment of RTP body as shown in FIG. 1 includes a thermoplastic reinforcement layer 120. The thermoplastic reinforcement layer may also be referred to as a reinforcement layer. The reinforcement layer 120 provides structural support to RTP body 100. In other words the reinforcement layer 120 may help to improve the resistance of RTP body to internal or external pressures, axial tensile forces, torsion, or the like. The reinforcement layer 120 is coaxial and radially external to the fluid retaining layer 110. As shown in FIG. 1, the reinforcement layer 120 is in physical contact with the fluid retaining layer 110. It will be appreciated that in some embodiments, the reinforcement layer 120 may be composed of a plurality of layers.

The reinforcement layer 120 is formed of one or more pairs of tapes cross-wound around the fluid retaining layer 110 with a lay angle of around +/−55° (not shown). In other words, each pair of tapes is wound helically in clockwise and counter clockwise directions respectively. It will be appreciated that, in other embodiments, the lay angle may be between 0° and 90°. In certain embodiments the pairs of tapes may be wound in regularly-separated hoops of a given radius. In certain embodiments the pairs of tapes may not be wound at all. It will be appreciated that the lay angle may be chosen depending on the reinforcement requirements of the reinforcement layer 120. For example, a shallower lay angle may provide greater resistance to axial forces along RTP body. The reinforcement tapes may be made of glass fiber/polymer matrix, carbon fiber/polymer matrix, aramid fiber/polymer matrix, steel fiber/polymer matrix, or the like. It will be appreciated that in other embodiments, the steel fibre may be exchanged for an alternative electrically conductive metal, polymer, carbon, ceramic, or the like, or a mixture of electrically conductive fibres and non-conductive reinforcement fibres where the electrically conductive fibres provide little or no structural reinforcement to the pipe body and purely act to facilitate consolidation of pipe layers. It will be appreciated that the steel fibre may itself be composed of multiple fibres threaded or otherwise bunched together. It will be appreciated that in other embodiments, the HDPE may be replaced by another polymer such as any polyethylene, a polypropylene, or a polyamide, PPS, polyvinylidene difluoride (PVDF) or the like.

It will also be appreciated that in some embodiments, the reinforcement layer 120 may comprise conductive fibres or strands or bunches of fibres which may be applied to the pipe without being incorporated into a tape (i.e. without a polymer matrix around the fibres).

RTP body also includes an outer sheath 130, which comprises a polymer layer used to protect the pipe against penetration of seawater and other external environments, corrosion, abrasion and mechanical damage. The outer sheath 130 is coaxial to the reinforcement layer 120 and the fluid retaining layer 110. As shown in FIG. 1, the outer sheath 130 is in physical contact with the reinforcement layer 120. The outer sheath is the outermost layer of RTP body 100. The outer sheath 130 is made of HDPE. The outer sheath 130 is tubular in shape and is manufactured using an extrusion process. It will be appreciated that in other embodiments, the outer sheath may consist of any polyethylene, a polypropylene, or a polyamide. It will be appreciated that in other embodiments, a manufacturing process such as extrusion, tape winding or the like may be used to make the outer sheath. Whilst the embodiment shown in FIG. 1 has three layers: the fluid retaining layer 110, the thermoplastic layer 120, and the outer sheath 130; it will be appreciated that in some embodiments described herein, RTP body may have the fluid retaining layer 110, a plurality of helically wound steel wires, and the outer sheath 130. In some embodiments, the plurality of steel wires (not shown) may be located radially between the fluid retaining layer 110 and the outer sheath 130.

The pipe bore 115 of RTP body 100 is hollow. Bore fluid is able to flow in a direction broadly parallel with the central axis A-A of RTP body 100. It will be appreciated that RTP body 100 may be deformed by external or internal forces without breaking. External forces may deform RTP body 100 and determine a shape adopted by the RTP.

Each RTP comprises at least one portion, referred to as a segment or section, of pipe body 100 together with a splice coupling (or end fitting) located at at least one end of the RTP. The splice coupling is a mechanical device which may form the transition between RTP body and a connector. The different pipe layers as shown, for example, in FIG. 1 are terminated in the splice coupling in such a way as to transfer the load between RTP body and the connector. It will be appreciated that RTP body 100 illustrated in FIG. 1 and henceforth may be bonded or unbonded RTP. It will be appreciated that bonded RTP refers to a process in which one or more layers of polymer are thermally solidified. In some cases, the layers of polymer and tape including the fluid retaining layer 110, the reinforcement layer 120, and the outer sheath 130 may be solidified into a single layer. Conversely, unbonded RTP may be understood as RTP body formed from individual layers that have not been thermally joined together.

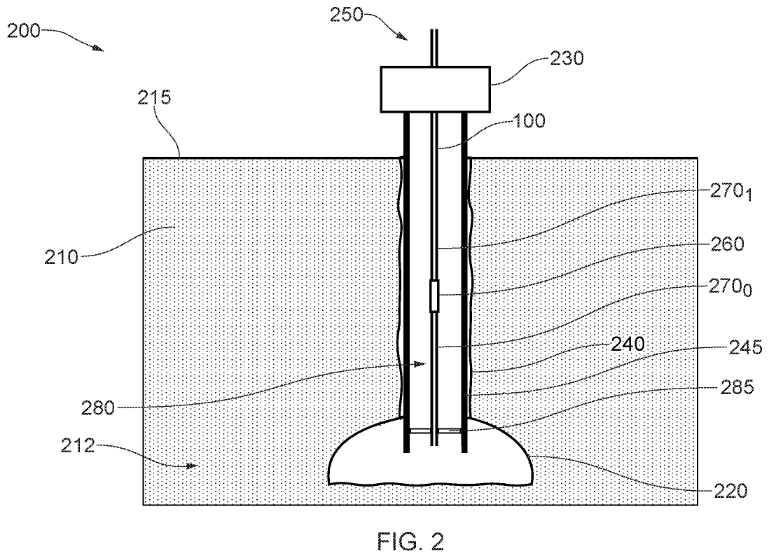

FIG. 2 illustrates a cross-section view of an onshore assembly 200 in a well surrounded by earth/ground 210. It will be appreciated that the cross-section illustrates a greatly simplified schematic of the onshore assembly 200 where only some features are shown. A below ground level 212 is illustrated near the bottom of FIG. 2. A ground level 215 is indicated. The assembly 200 is suitable for transporting production fluid such as oil and/or gas and/or water from an oil and gas well 220 (at the below ground level 212) to a well head 230 normally located above or near ground level 215. It will be appreciated that the well head 230 may refer to any structural component at surface level of the oil/gas well 220. The oil well 220 is connected to the well head 230 via a borehole 240. In certain embodiments the borehole 240 is formed in the earth 210 by drilling, excavation or the like. Specifically, the oil well 220 is in fluid communication with the well head 230 through a well casing 245. The well casing 245 is usually a rigid steel pipe concentrically inside the borehole 240. In certain embodiments, the well casing 245 is a flexible pipe, RTP, or the like. In certain embodiments, the well casing 245 is provided by a rigid pipe formed of metal, metal alloy, steel, or the like. It will be appreciated that the well casing 245 may have multiple layers or alternatively a single layer (as illustrated in FIG. 2).

Inside the well casing 245 is a velocity string 250. As is known, velocity strings 250 have many functions including facilitating extraction of resources from the well 220 at a lower pressure than would otherwise be required. The velocity string 250 illustrated in FIG. 2 is made of two segments 270 of RTP body 100 (two sections shown) and a swage splice coupling 260. Together, one segment of RTP body 270 and the splice coupling 260 may be called a Reinforced Thermoplastic Pipe (RTP) 280. In certain embodiments RTP 280 may be a plurality of segments of RTP body 270 and one or more splice couplings 260. One segment of RTP body 270₀ is connected to another segment of RTP body 270₁ by the splice coupling 260. It will be appreciated that in some embodiments, there may be splice couplings 260 on each end of the segment of RTP body 270_{0,1}. In certain embodiments, one splice coupling 260 of one segment of RTP body 270 may be connected to another splice coupling 260 of another segment of RTP body 270. In certain embodiments the splice coupling 260 may be an end fitting, a connector, or the like. Optionally the velocity string 250 may have a collar 285 which prevents fluid from flowing outside of the velocity string 250 up the well casing 245 therefore increasing fluid pressure. The collar 285 may be rigid or flexible and made from a plastic, composite, metal, or the like.

The onshore assembly 200 in FIG. 2 illustrates how segments of RTP 270_{0,1} can be utilised as the velocity string 250, but it will be appreciated that the RTP 270 may alternatively or additionally be used for downhole tubing, mining applications, and the like. The segments of RTP body 270 illustrated in FIG. 2 are suspended vertically (as defined by gravity) and is supported near the well head 230 by supporting apparatus (not shown). In certain embodiments, the RTP segments 270 are oriented in a horizontal direction or a horizontal and vertical direction. The segments of the RTP body 270 in the onshore assembly 200 can have different pipe diameters, can withstand different pressures, and can have other specification differences according to their use. Some examples of configurations of RTP 280 that may be applicable herein are RTP used in horizontal pipelines defined in American Petroleum Institute (API) 15S. It will be appreciated that in other embodiments, the RTP body and the splice couplings may be used for different purposes such as water disposal pipes, gas injection pipes, produced gas pipes, CO₂ export pipes, and the like.

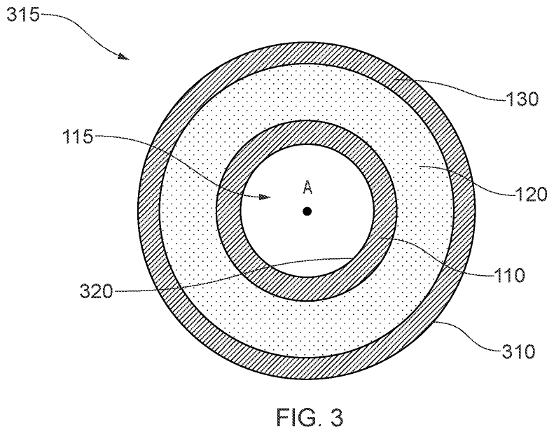

FIG. 3 illustrates a cross-section of RTP body 100. The central axis A-A is oriented in FIG. 3 such that A-A extends in a direction perpendicular to the cross-section. The layers shown in FIG. 1 are visible, including the innermost fluid retaining layer 110, the reinforcement layer 120, and the outer sheath 130. It will be appreciated that in other embodiments, any layer of RTP body may be composed of a plurality of layers.

As shown in FIG. 3, the reinforcement layer 120 is coaxial with the fluid retaining layer 110. Likewise, the outer sheath 130 is coaxial with the fluid retaining layer 110. The internal diameter of the reinforcement layer 120 is greater than the internal diameter of the fluid retaining layer 110. The internal diameter of the outer sheath 130 is greater than the internal diameter of the reinforcement layer 120 or the internal diameter of the fluid retaining layer 110.

In FIG. 3, an outer surface 310 of RTP body 100 is visible. The outer surface 310 is exposed to an external environment 315. The environment 315 may be an offshore or onshore environment. An inner surface 320 of RTP body 100 is also visible. The inner surface 320 defines the pipe bore 115. The pipe bore 115 in FIG. 3 is 3 inches (76.2 mm). It will be appreciated that in other embodiments, the pipe bore 115 may be larger or smaller than 3 inches (76.2 mm), for example between 2 inches (50.8 mm) and 4 inches (101.6 mm), or even larger. The inner surface 320 is often in contact with the bore fluid. The bore fluid may be a liquid or a gas or a combination of liquid and gas.

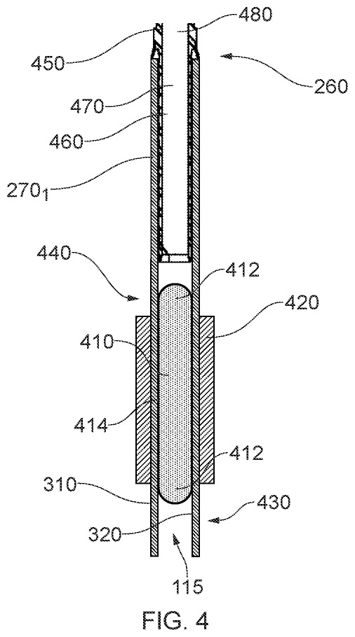

FIG. 4 illustrates in cross-section how an end of the segment of RTP body 270₁ may be supported in use. It will be appreciated that the segment of RTP body 270₁ is shown in greatly simplified form and contains multiple layers as illustrated in previous Figures. The segment of RTP body 270₁ is attached to the splice coupling 260. In FIG. 4, a brace member 410 is provided in the bore 115 of RTP body 100 and a clamp 420 grips an outer surface 430 of RTP body segment 270₁. In certain embodiments, the brace member 410 may be a plug. In certain embodiments, the brace member 410 may be a collapse resistant body. In certain embodiments, the brace member 410 may be a rigid body.

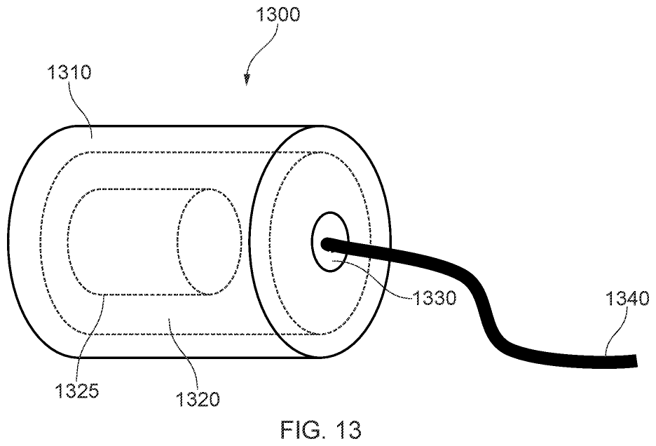

The brace member 410 is generally pill-shaped. That is to say, the brace member 410 has a cylindrical cross-section along a majority of its axial dimension bounded by rounded ends 412. In certain embodiments, the brace member 410 has a cylindrical shape (for example as illustrated in FIGS. 13-15). In certain embodiments the brace member 410 has a spherical, cuboidal, cubic, or the like shape. The brace member 410 has an external surface 414 that in use is in physical contact with the inner surface 320 of RTP body 100. The external surface 414 and by extension the brace member 410 as a whole, supports the inner surface 320 of RTP body 100 against radially inwards forces exerted on the outer surface 310 of RTP body 100.

The splice coupling 260 is constructed with a tapered end 450. The tapered end 450 may directly engage with another RTP body segment 270. In certain embodiments the splice coupling 260 may join end-to-end with another splice coupling 260. That is to say in certain embodiments each RTP body segment 270 may engage with different splice couplings 260 such that the splice couplings 260 may be joined. Two segments of RTP body 270 are in fluid communication when joined by one or more splice couplings 260. The splice coupling 260 includes a body section 460 for swaging with the RTP body segment 270. The splice coupling 260 further includes a chamber 470 providing a fluid connection between the first segment of RTP body 270₁ and another segment of RTP body 270. The splice coupling 260 also includes an opening 480. It will be appreciated that the splice coupling 260 may include numerous additional features not illustrated in the symbolic representation shown in FIG. 4.

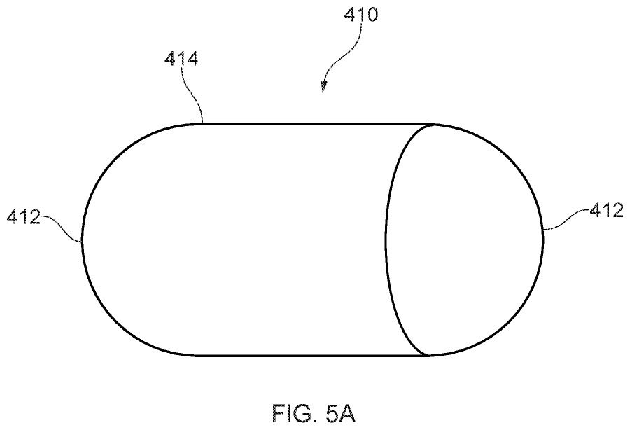

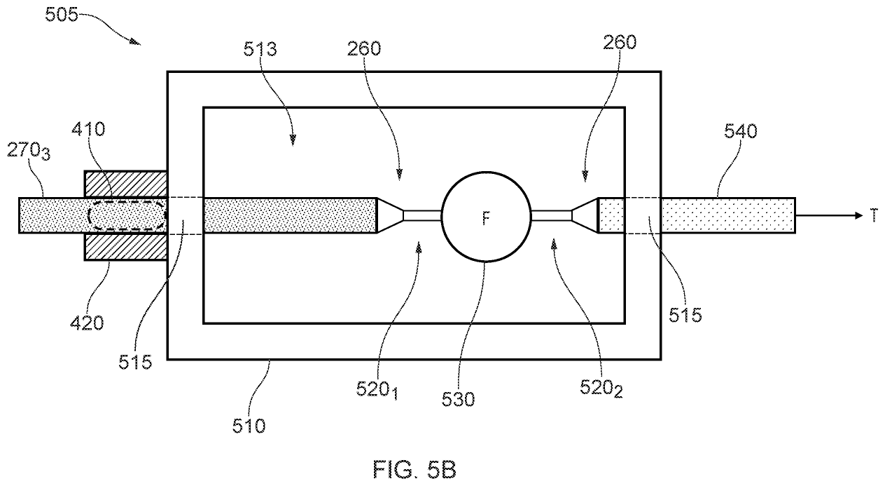

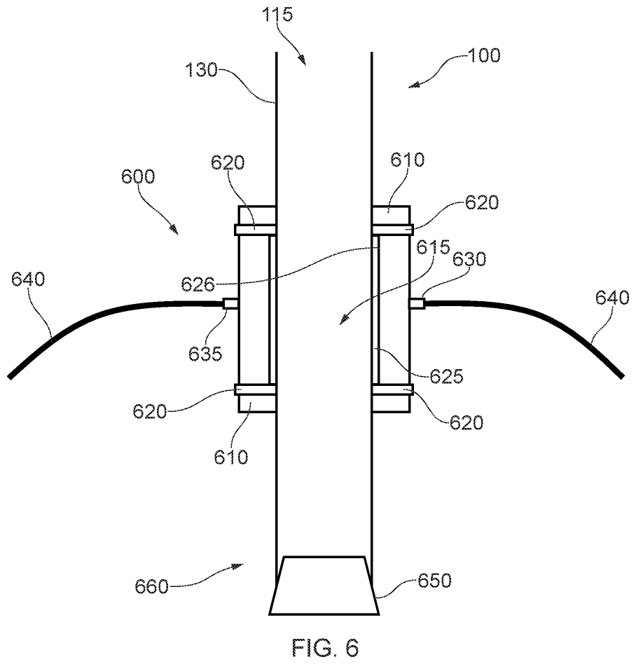

In certain embodiments, the brace member 410 is located in a covered portion 440 of the bore 115. In particular, the clamp 420 is in physical contact with the outer surface 430 of the outer sheath 130 of RTP body 100. In certain embodiments, the covered portion 440 is a region of space defined by being internal to the clamp 420. In certain embodiments the covered portion 440 may be a space radially internal to the clamp 420. In FIG. 4, the brace 410 is a frozen brace member. In certain embodiments, the frozen brace member 410 is a solid structure, although it will be appreciated that the frozen brace member 410 could alternatively be a hollow brace member, or the like. The frozen brace member 410 illustrated in FIG. 4 is broadly cylindrical in shape (shown in more detail in FIG. 5). In certain embodiments the frozen brace member 410 is a solid, broadly cylindrical apparatus formed from ice. Means for forming the frozen brace member 410 is shown in FIG. 6. It will be appreciated that the frozen brace member 410 may alternatively be a dissolvable brace member, an inflatable brace member, a gel brace member, or the like. Alternative options are discussed in more detail below.

During pipe deployment, the RTP body segment 270₁ is supported by the clamp 420. The wellhead 230 may be connected to the well 220 vertically below it through many metres or kilometres of RTP body 100. It will be appreciated that although only a portion of the RTP body segment 270₁ is shown in FIG. 4, many metres or even kilometres of RTP body 100 may be suspended and supported from a position near or at ground level. When the clamp 420 is in use, a radially inwards gripping force is applied by the clamp 420 to the outer surface 430 of the RTP body segment 270₁. The gripping force helps to provide a friction force which resists axial movement (vertically down in FIG. 4) of the RTP body segment 270₁. Therefore, the friction force supports the self-weight of the suspended section of one or more segments of RTP body 270. It will be appreciated that the required gripping force of the clamp 420 is a function of the static coefficient of friction between the clamp 420 and outer surface 430 and weight/mass of the one or more RTP body segments 270.

When the RTP body segment 270₁ is being supported by the clamp 420, a radially inwards force is applied to the outer surface 430 of the outer sheath 130 of RTP body 100. To prevent the RTP body segment 270₁ from collapsing or otherwise failing due to the applied force, the brace member 410 is positioned in the covered portion 440. In certain embodiments, at least some of the gripping force of the clamp 420 is applied to the brace member 410. In certain embodiments, the brace member 410 may help to increase a magnitude of the gripping force applied by the clamp 420 to the outer curved surface 430 of the RTP body segment 270₁ without the segment 270 failing. In certain embodiments, failing may be understood as referring to development of any structural defect in the RTP body segment 270 as a result of a compressive force, including but not limited to: buckling of RTP body 100, peeling of the outer sheath 130, and tearing of the outer sheath 130.

FIG. 5A illustrates the frozen brace member 410. The frozen brace member 410 has rounded edges 412 and external surface 414 as previously described. As mentioned previously, the brace member 410 may alternatively be referred to as any of: a plug, a collapse resistant body, a rigid body, a structural support, or the like. In certain embodiments, the brace member 410 may alternatively be provided by a hardening gel as a gel brace member. In certain embodiments, the brace member 410 may alternatively be provided by inflation with a liquid/gas as an inflatable brace member. In certain embodiments, the brace member 410 may alternatively be provided as a dissolvable brace member that can be dissolved by chemical action. Where the brace member 410 includes a hollow space it may be referred to as a tubular brace member or a hollow brace member.

The brace member 410 is intended to friction fit in the bore 115 of the RTP body segment 270₁. Therefore, the brace member 410 has an outer diameter of 6″ (152.4 mm). In certain embodiments the outer diameter is between around 1″ (25.4 mm) to around 10″ (254 mm) depending on the bore diameter of the RTP body segment 270 the brace member 410 is to be used with. The brace member 410 also intended to support a compressive force provided by the clamp 420 without breaking. Optionally the brace member 410 has a radial compression resistance at least able to withstand a radial clamping force sufficient for a resulting friction force on a test piece to resist a tension force of at least 10 kN (kilo newtons) and preferably 70 kN (kilo newtons) applied along a longitudinal axis of the test piece.

It will be appreciated that possible tests for measuring the performance of the brace member 410 can be used. Examples of performance tests for the brace member are outlined below, including a tension test adapted from ISO 3501 (illustrated in FIG. 5B).

A standard compression test may be used during manufacturing of the brace member 410 to determine how the brace member 410 (or any brace, plug, collapse resistant body, rigid body, or the like) performs when a compressive force is applied in a radial direction, similar to how the clamp 420 would exert force on the brace member 410. In the test, the brace member 410 is placed on a flat surface and a known compressive (crushing) force is incrementally applied to the brace member 410 through a plate. The compressive force at which the brace member 410 fails, combined with contact area between the plate and the brace member 410 may be used to calculate the compressive strength of the brace member 410 in pascals/newtons per square metre. In certain embodiments another test involves incrementally increasing crushing force applied by the clamp 420 directly on the brace member 410 until failure and measuring the force applied at the point of failure, In certain embodiments the compressive strength of the brace member 410 is 100 Pa. In certain embodiments the compressive strength of the brace member 410 is 100 kPa. In certain embodiments the compressive strength of the brace member 410 is 100 mPa. In certain embodiments the compressive strength of the brace member 410 is 100 gPa.

Compression resistance is a performance characteristic for the brace member 410 because during use the brace member 410 is subjected to a radial clamping force provided by the clamp 420 on the outer surface 310 of the covered portion of RTP body 100 that the brace member 410 is supporting. In use the radial clamping force results in a reaction force between the outer surface 310 and the clamp 420, providing a maximum static friction force, proportional to the reaction force and a static coefficient of friction between the outer surface 310 of RTP body 100 and the clamp 420, which can counteract a longitudinal tension force acting on RTP body 100 during deployment.

Alternatively, or additionally, compressive strength of the brace member 410 may be estimated through calculation. For example, material properties such as the compressive strength (which for ice is around 5-25 Mega Pascals) can be applied to actual surface area of the brace member 410 exposed to a compressive force to evaluate performance.

FIG. 5B illustrates a possible compression resistance test adapted from ISO 3501 using a test machine 505 to test performance of the brace member 410. The possible compression resistance test could be used in a manufacturing process for producing the brace member 410 to ensure that certain performance requirement/s of the brace member 410 are met in the end product. The possible compression resistance test may therefore assist during manufacture of any brace member and is not present when the brace member 410 is in use supporting RTP body. It will be appreciated that the example test shown in FIG. 5B is a simplification that shows only select features.

In FIG. 5B, a segment of RTP body 2703 (a test piece) containing the brace member 410 is fed into a loading framework 510 of the test machine 505 and connected via the splice coupling 260 to a first connection point 5201 of an optional force meter 530. The load framework 510 may be assembled in accordance with ISO 3501. Optionally the load framework 510 has a rectangular outer perimeter, optionally with a 2:1 ratio length:width formed from four square section members joined together providing an open centre region 513. Optionally two openings 515 in the loading framework 510 each allow a pipe to pass into the open centre region 513. The openings 515 are smaller in diameter than the width of the clamp 420 thereby preventing the clamp 420 from moving through abutment to the loading framework 510. Alternatively the clamp 420 is mounted to the loading framework 510. RTP body 100 is gripped by the clamp 420, preventing RTP 100 from being pulled further into the loading framework 510. The loading framework 510 is constructed from steel, although it will be appreciated that any material for providing a suitably rigid frame could be used instead, including a metal, metal alloy, wood, plastic, composite, or the like. The adapter 520 enables RTP body 100 to be terminated and provides a connection point for fixing to the force meter 530. The force meter 530 measures a tensile force applied to it by the first connection point 5201 and a second connection point 5202. The second connection point 5202 is connected via the splice coupling 260 to a cable 540 and a tension force T is applied along a longitudinal axis of the test piece (segment of RTP body 2703). The tension force T may be applied via the cable 540. The cable 540 is constructed from steel, although any combination of metal, metal alloy, plastic, composite, fibre, or the like could be used instead. In some embodiments the cable 540 may be a segment of RTP body 2704. It will be appreciated that the tension force T could be applied in many other way such as using a lever mechanism described in ISO 3501. Optionally the segment of RTP body 2703 (test piece) is a free length of RTP body as defined in ISO 3501. Optionally the tension force is applied as a constant load force to a first end of the free length of RTP body as defined in ISO 3501.

In certain embodiments the collapse resistant body has a radial compression resistance at least able to withstand a radial clamping force sufficient for a resulting friction force on a test piece to resist a tension force of 70 kN (kilo newtons) applied along a longitudinal axis of the test piece.

During the possible compression resistance test the clamp 420 applies radial pressure on the RTP body 100 in order to restrain the tension force T applied to the end connection applied to the segment of RTP body 2703 through the cable 540 and force meter 530. A successful outcome of the test would be for the segment of RTP body 2703 to withstand axial loading of at least 20 kN (kilo newtons), preferably 70 kN (kilo newtons), by being supported by the brace member 410, without suffering failure of any kind. Failure may include any one or more of: failure of any part of the RTP pipe body, stripping/tearing of the outer layer 130 of the RTP body 100, crushing of RTP body 100, and failure of the connection with the end fitting 260.

In some embodiments the possible compression resistance test may involve any of the following steps. A constant tensile force is applied along a longitudinal axis of RTP body as specified in ISO 3501 at an end of a free length of RTP body specified in ISO 3501. Optionally a fitting to be tested according to ISO 3501 is replaced with the brace member 410 which is placed in and thereby supports the bore 115 of the free length of RTP body at a covered region. Optionally the brace member 410 cooperates with the clamp 420 that produces a radial clamping force on the outer surface 310 of the free length of RTP body at the covered region. Optionally the clamp 420 is arranged to be on an opposing side of and in abutment with the loading framework 510 (loading framework specified in ISO 3501) to the end of the free length of RTP body. Optionally the loading framework 510 prevents the clamp 420 from moving in a direction of the constant tensile force thus preventing the free length of RTP body from moving through a resulting friction force between the brace member 410 and the clamp 420.

In certain embodiments, Youngs Modulus may be measured during manufacturing or calculated as a performance measure of the brace member 410. In certain embodiments, Youngs Modulus for the brace member 410 may be at least 8 GPa (gigapascals) at typical operating temperature. In certain embodiments a standard Youngs Modulus test may be used by measuring strain of the brace member 410 at different applied compressive forces, measuring the force applied and thereby calculating the pressure applied by dividing force by surface area of applied force, and using this information to calculate stress/strain during a period of linear change in strain relative to stress.

In certain embodiments, hardness may be measured during manufacturing or calculated as a performance measure of the brace member 410. In certain embodiments hardness of the brace member 410 on the Brinell scale may be at least 4. In certain embodiments a standard Brinell hardness test may be used by indenting the brace member 410 with a 10 mm diameter steel ball and measuring the deformation. In certain embodiments hardness may be measured according to the Rockwell R scale. Preferably the external surface 414 of the brace member 410 has a hardness on the Rockwell R scale of 50 or more. It will be appreciated that Rockwell hardness may be determined using a standard Rockwell hardness tester. In certain embodiments hardness may be measured according to the Shore D scale. Preferably the external surface 414 of the brace member 410 has a hardness on the Shore D scale of 30 or more. It will be appreciated that Shore hardness may be determined using a standard shore hardness tester and/or a Shore D Durometer. In certain embodiments the frozen brace member 410 is capable of supporting a compressive pressure, up to 25 MPa, applied by the clamp 420.

The shape and configuration of the brace 410 together with the material selected for the Brace body are selected so that when an expected clamping pressure is exerted to hold a segment of flexible pipe at a desired location the pipe does not deform to the extent that its performance thereafter is impeded. That is to say some minor deformation of one or more layers of the pipe body may be accommodated by a partial collapse of the brace but the collapse is resisted to the extent that after clamping (or during operation with a tubular brace in place) fluid can be conveyed and the expected lifespan of operation of the pipe is not significantly degraded by the clamping. For some embodiments the brace is so rigid and hard that it fully resists any radially inwards motion under any expected clamping force.

FIG. 6 illustrates how the frozen brace member 410 can be formed in the bore 115 of RTP body 100. A pipe freezer 600 is secured on the outer surface 310 of RTP body 100 around the outer sheath 130. The pipe freezer 600 includes a tubular-shaped sleeve 610 that is slid along (or wrapped around) the outer sheath 130 to a desired position 615. In certain embodiments the space inside the desired position 615 is defined as the covered portion 440. In certain embodiments, the sleeve 610 is filled with an insulating material. The sleeve 610 optionally includes two straps 620 for tightening the sleeve 610 near each axial end of the sleeve 610. In certain embodiments, the sleeve 610 may include one, two, or more straps 620. In certain embodiments, the straps 620 may alternatively be strings, elastic, or the like. A chamber 625 is formed between an inner surface 626 of the sleeve 610 and the outer surface 430 of the RTP body segment 270₁. The sleeve 610 also includes a first pipe interface 630 and an optional second pipe interface 635 (two shown). In FIG. 6, the pipe interfaces 630, 635 are threaded tubes for attaching to pipe hose 640. The pipe interfaces 630, 635 provide a fluid connection between pipe hose 640 and the chamber 625. In certain embodiments, a gas or liquid is supplied through pipe hose 640 to the sleeve 610. In certain embodiments, liquid CO₂ is supplied to the sleeve 610. In certain embodiments, the first pipe interface 630 provides an inlet for fluid to the sleeve 610. In certain embodiments, the second pipe interface 635 provides an exhaust for fluid from the sleeve 610. FIG. 6 also shows an optional stopper 650. It will be appreciated that the stopper 650 may be provided by any device capable of preventing water from exiting the bore 115 from one end of the RTP body segment 270₁. In certain embodiments, the stopper 650 is formed of rubber, plastic, or the like and forms a friction fit with the bore 115 in use.

To produce the frozen brace member 410 the pipe freezer 600 shown in FIG. 6 may be operated as follows. The sleeve 610 is positioned around the outer surface 430 of RTP body 100 in the desired position 615. The straps 620 are tightened to hold the sleeve 610 in place. The bore 115 is at least partially filed with water. The stopper 650 is pressed into the bore 115 at an end 660 of the RTP body segment 270₁ to contain water in the bore 115. Liquid CO₂ is pumped through the pipe hose 640 to the sleeve 610 where it fills the chamber 625, cooling the outer surface 430 of the RTP body segment 270₁ therefore cooling RTP body 100 at the desired position 615, thus freezing the water in the bore 115 at the desired position and forming the frozen brace member 410.

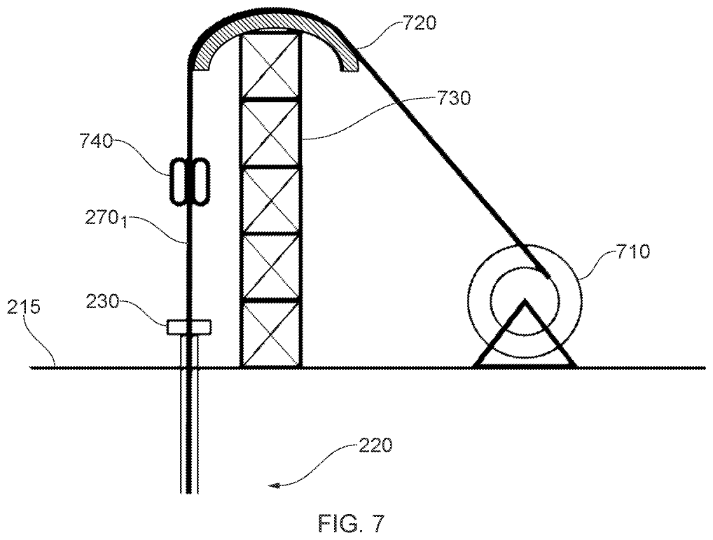

FIGS. 7 to 12 illustrate how the brace member 410 is used to support RTP body 100 and to facilitate attachment of a second RTP body segment 270₂ to the suspended RTP body segment/s 270_{1,0} at the well head 230. The process outlined in the following figures may be used when the full length of the RTP body segment 270₁ has been deployed and it is necessary to join another length of the RTP body segment 270₂. Prior to the process outlined below it will be appreciated that pipe deployment (broadly, unravelling RTP and/or lowering it towards the well) is temporarily stopped. It will be appreciated that the figures are greatly simplified and only show some features.

In FIG. 7 the first segment of RTP body 270₁ is deployed as a velocity string. During deployment, the first RTP body segment 270₁ is unwrapped from a reel 710 and guided through the well head 230 down to the well 220. The first RTP body segment 270₁ passes over a guide track 720 which is supported by a guide track tower 730. The guide track 720 may be known as a goose neck 720. The tower 730 is a solid structure that may be capable of supporting kilometres of RTP body 100. In certain embodiments the tower 730 is formed from a truss structure. In certain embodiments the tower 730 is formed from steel. The goose neck 720 helps to limit curvature of RTP body 100 to prevent damage and/or to act as a pulley helping to angle the tensioned first RTP body segment 270₁. It will be appreciated that there may be friction acting between the first RTP body segment 270₁ and the goose neck 720. The first RTP body segment 270₁ also passes between a pair of pipe tensioner tracks 740. In certain embodiments the first RTP body segment 270₁ is in physical contact with the pipe tensioner tracks 740. In certain embodiments, the pipe tensioner tracks 740 may form an assembly with caterpillar tracks and at least one motor to facilitate increasing tension in the RTP 270 vertically below the tensioners 740 in FIG. 7. In certain embodiments the pipe tensioner tracks 740 may help to provide a lifting force to the RTP body segments 270_{0,1} upwards as shown in FIG. 7.

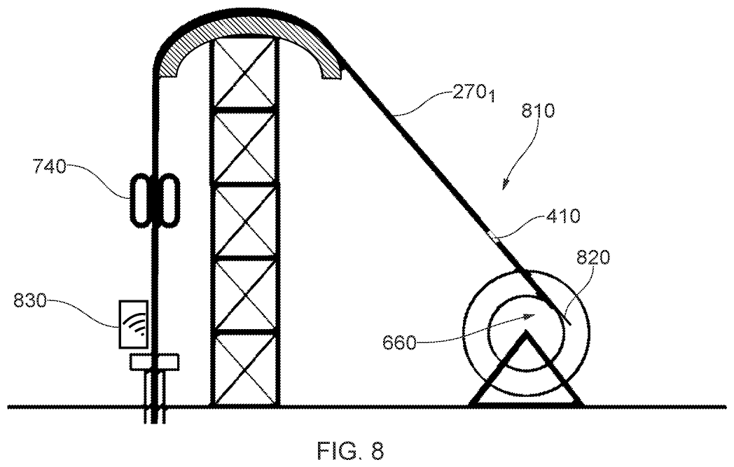

FIG. 8 illustrates the frozen brace member 410 in the bore 115 of the first RTP body segment 270₁. The frozen brace member 410 may be formed by the method described in FIG. 6 or by any other method. In certain embodiments the brace member 410 may be formed outside the bore 115 and moved into position afterwards. As previously mentioned, it will be appreciated that the frozen brace member 410 may alternatively be replaced with a different kind of brace member. Some examples of alternative brace members are outlined below.

Once the brace member 410 has been formed it may optionally be moved to a predetermined position 810 in the bore 115. It will be appreciated that some brace member 410 formations may involve forming the brace member 410 at the predetermined position 810, removing the need for movement of the brace member 410 afterwards. FIG. 8 shows a locating tool 820, here provided by a rigid rod, for moving the brace member 410 axially though the bore 115 to the predetermined position 810. In certain embodiments the rigid rod 820 is inserted into the end 660 of the first RTP body segment 270₁ to push the brace member 410 into the position 810. It will be appreciated that the predetermined position 810 may be chosen to correspond to the covered portion 440 when the clamp 420 is positioned around the segment of RTP body 270.

The locating tool 820 could alternatively be a magnet or electromagnetic for a magnetic brace member, a wire or rope, or the like. In certain embodiments the brace member 410 is inserted and/or positioned using a window through the layers 130,120,110 of RTP body 100 providing access to the bore 115. In certain embodiments the brace member 410 is inserted and/or positioned through a remaining free end of the first RTP body segment 270₁, which may be a large distance below the ground level 215. It will be appreciated that the brace member 410 may not move freely (i.e., without an external force applied to push the brace member) because it has a similar outer diameter to the inner diameter of the bore 115 and therefore is held in position by a friction fit.

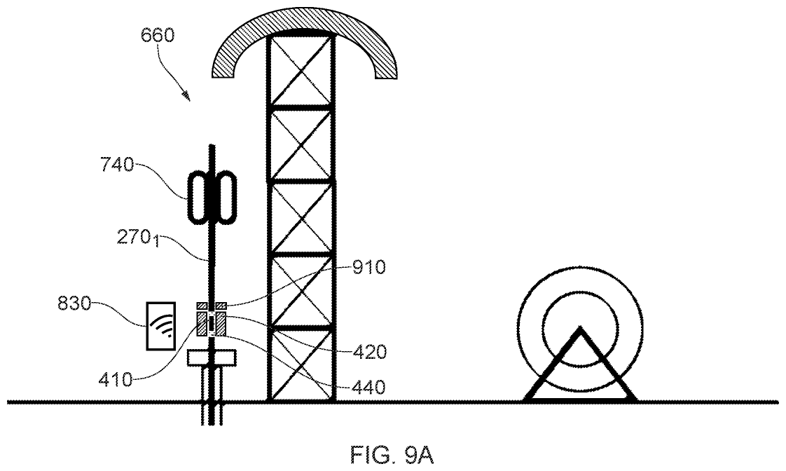

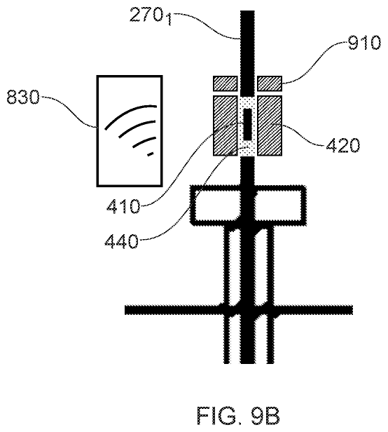

In certain embodiments the brace member 410 has an indicator that can be detected by an optional detector 830 outside of the bore 115. In certain embodiments the brace member 410 is magnetic and can be detected by the metal detector 830 outside of the bore 115. In certain embodiments the brace member 410 contains a radioactive source and can be detected by the radiation detector 830. In certain embodiments the brace member 410 contains a sound or light source and can be detected by the corresponding detector 830. In certain embodiments the brace member 410 can be detected (is detectable) by the ultrasonic detector 830 by sending and reflecting high frequency sound waves. The detector 830 is used to detect the position of the brace member 410 through the RTP body segment 270. In certain embodiments the detector 830 is used to position the clamp 420 as illustrated in FIG. 9. In certain embodiments the detector 830 is used to position the brace 410 upon entry at the end 660 of the first RTP body segment 270₁.

FIG. 9A illustrates the clamp 420 installed around the first RTP body segment 270₁ providing the covered portion 440. The frozen brace member 410 is located at least partially in covered portion 440 of the bore 115. In certain embodiments the frozen brace member 410 may be located elsewhere to the covered portion 440. The configuration near the clamp 420 is shown in more detail in FIG. 9B. In FIGS. 9A-B, the end 660 of the first RTP body segment 270₁ has been released from the reel 710 and allowed to pass back over the guide track 730 and is located above the pipe tensioner tracks 740. In certain embodiments the first RTP body segment 270₁ is prevented from falling into the well 220 by the pipe tensioner tracks 740 and/or the clamp 420. It will be appreciated that the pipe tensioner tracks 740 may not provide room for the swage coupling 260 to pass through, therefore, it may be necessary to clamp the RTP body segment 270₁ after the pipe tensioner tracks 740 using the clamp 420 so that the swage coupling 260 can be fitted to an end of the RTP body segment 270₁.

The clamp 420 provides a compressive force on the RTP body segment 270₁ at the covered portion 440. In certain embodiments the clamp 420 includes tightening bolts, latches or the like for maintaining the compressive force. In certain embodiments the brace member 410 supports RTP body 100 of the first RTP 270₁ against the compressive force of the clamp 420. In certain embodiments friction acts between the clamp 420 and the outer surface 430 of the first RTP body segment 270₁. In certain embodiments the friction prevents the clamp 420 from sliding against the outer surface 430. In certain embodiments the brace member 410 prevents the outer sheath 130 from tearing and/or RTP body 100 from being crushed.

A C-plate 910 is installed on/near the clamp 420 to support the first RTP body segment 270₁. In certain embodiments the C-plate 910 is installed above the covered portion 440 as defined by the axis of the segment of RTP body 270₁ at the covered portion 440. In certain embodiments the C-plate 910 is installed below the covered portion 440 as defined by the axis of the segment of RTP body 270₁ at the covered portion 440. In certain embodiments the C-plate 910 holds the first RTP body segment 270₁ on the well head 230. In certain embodiments the C-plate 910 helps to prevent the first RTP body segment 270₁ from falling into the well 220.

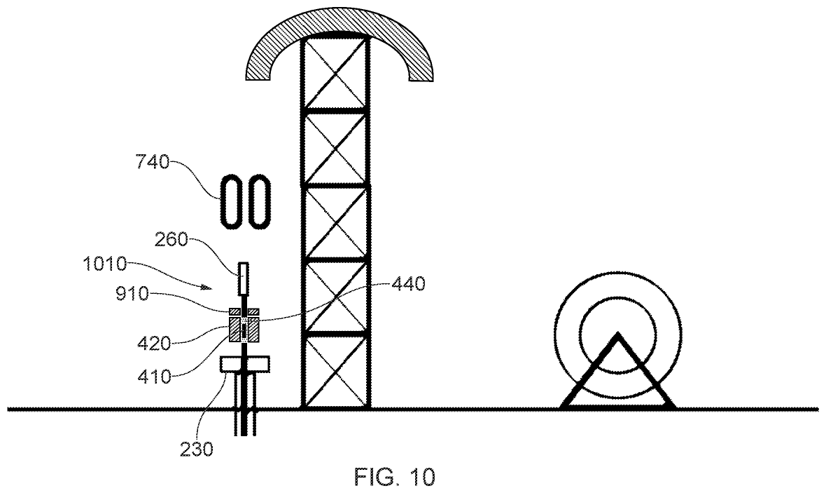

FIG. 10 illustrates the first RTP body segment 270₁ supported by the brace member 410 and the clamp 420. In FIG. 10, the end 660 of the first RTP body segment 270₁ is cut above the clamp 420 providing a free end 1010 of the first RTP body segment 270₁. The cut end of the first RTP body segment 270₁ is removed and thus the first RTP body segment 270₁ (and any previous RTP body segment 270₀ as illustrated in FIG. 2) is temporarily supported by the clamp 420, brace member 410 and C-plate 910. It will be appreciated that the clamping force provided by the clamp 420 may be sufficient to produce a suitable reaction force at the outer surface 430 and thus a large enough friction force to completely counteract the self-weight of the first RTP body segment 270₁ and any segments 270 attached to it.

The splice coupling 260 is attached at the free end 1010 of the first RTP body segment 270₁. In certain embodiments the splice coupling 260 is an end fitting. In certain embodiments the splice coupling 260 is swaged onto the first RTP body segment 270₁. In certain embodiments the splice coupling 260 and the RTP body segment 270₁ are connected. It will be appreciated that the brace member 410, clamp 420 and the C-plate 910 may be needed because the splice coupling 260 would not fit through the pipe tensioner tracks 740 if installed on the first RTP body segment 270₁ prior to feeding the first RTP body segment 270₁ through the tensioner.

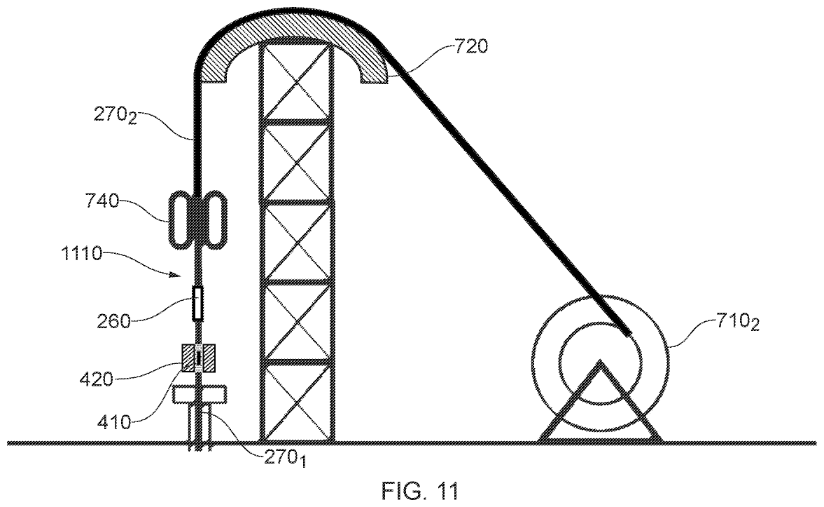

FIG. 11 illustrates the first RTP body segment 270₁ and the second RTP body segment 270₂. The pipe tensioner tracks 740 are disengaged. The first reel 710 is removed. In certain embodiments the reel 710 is mounted on a trailer and towed away by a vehicle. A second reel 7102 is moved into position. The second RTP body segment 270₂ is partially unrolled from the second reel 7102, passed over the guide track 720 and through the pipe tensioner tracks 740. A free end 1110 of the second RTP body segment 270₂ is positioned near the splice coupling 260.

The free end 1110 of the second RTP body segment 270₂ is attached to the splice coupling (swage splice coupling) 260. In certain embodiments, the free end 1110 is swaged into the swage splice coupling 260. Alternatively, in an embodiment, a second splice coupling 260 is attached to the free end 1110 of the second RTP body segment 270₂ and then the splice couplings 260 of the first and second RTP body segments 270_{1,2} are joined. During the joining process, the RTP body segments 270 are supported by the clamp 420 and the brace member 410.

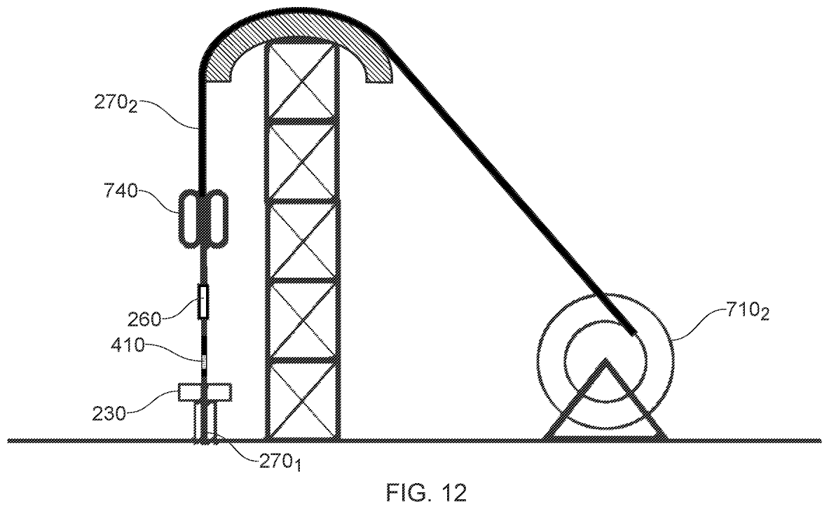

FIG. 12 illustrates continuation of pipe deployment. The pipe tensioner track 740 is re-engaged on the second RTP body segment 270₂. The C-plate 910 and the clamp 420 are removed. The frozen brace member 410 is left to melt in the bore 115 due to the higher-than-freezing temperature of the ambient environment. The frozen brace member 410 then freely slips through the bore 115 without blocking the RTP body segment 270. It will be appreciated that in alternative embodiments, the brace member 410 may be cleared by different methods. In any case, the end effect of clearance of the brace member 410—that the bore 115 is left un-blocked—is the same.

Pipe deployment continues through controlled rotation of the reel 710 to unravel the RTP body segment 270₂ from the reel (anti-clockwise direction in FIG. 12). The pipe tensioner tracks 740 allow the RTP body segment 270₂ to be lowered through the wellhead 230. It will be appreciated that in alternative embodiments pipe deployment may involve laying pipe horizontally or at any angle between horizontal and vertical relative to gravity (or as shown in FIG. 12). It will be appreciated that the process outlined above with respect to FIGS. 7-12 may be repeated again when the second RTP body segment 270₂ has been fully unraveled from the reel 710.

FIGS. 13 to 16 illustrate alternative brace members. It will be appreciated that the alternative brace members may be used in place of the frozen brace member 410.

FIG. 13 illustrates an alternative brace member 1300. The brace member is an inflatable brace member 1300. The inflatable brace member 1300 may be referred to a tubular brace member or a hollow brace member. It will be appreciated that the inflatable brace member 1300 may provide the same function, meet the same standards and be tested in the same way as the frozen brace member 410 described with respect to FIGS. 4 and 5. In certain embodiments the frozen brace member 410 may be replaced with the inflatable brace member 1300 and the inflatable brace member 1300 may also successfully support RTP body 100 from an external clamping force provided by the clamp 420. In certain embodiments some differences between the frozen brace member 410 and the inflatable brace member 1300 include that they are formed differently and they are removed from the bore 115 differently.

The inflatable brace member 1300 has a broadly cylindrical outer surface that contacts the surface of the bore 115 in use. The inflatable brace member 1300 is formed of a flexible hollow body of inflatable material. The brace member 1300 has an inflatable outer shell 1310 and a hollow internal chamber 1320 that may be filled with a fluid. The inflatable outer shell 1310 can help to provide a bladder. The inflatable shell 1310 is formed of a flexible material such as an elastomer material, a polyolefin material, or the like.

In certain embodiments the inflatable shell 1310 is formed of elastomer, a low-density polyethylene (LDPE), a plastic, a plastic and aramid fibre composite, a metal, an alloy, a composite or the like. In certain embodiments the inflatable shell 1310 is formed of a plurality of layers. In certain embodiments the plurality of layers are made from different materials. In certain embodiments the plurality of layers are made from the same material. It will be appreciated that the inflatable shell 1310 may expand in all dimensions when the pressure of fluid in the internal chamber 1320 is sufficiently high.

In certain embodiments the inflatable brace member 1300 also contains a solid body 1325 which at least partially fills the internal chamber 1320 of the inflatable brace member prior to inflation. The solid body 1315 may have the advantage of limiting the volume required to inflate the inflatable brace member 1300 and the time required to perform the inflation. The solid body 1315 may be constructed from the same materials as the inflatable shell 1310 or different materials including but not limited to thermoplastic polymer, a metal fabrication, or a combination of materials. The solid body 1315 may be cylindrical as illustrated in FIG. 13. Optionally, the solid body 1315 may be cubical, cuboidal, spherical, or the like.

In certain embodiments the inflatable brace member 1300 is capable of supporting an internal pressure up to around 5 to 35 mega pascals (MPa) without bursting or failing. In certain embodiments the inflatable brace member 1300 may be inflated to a desired internal pressure to enable the brace member 1300 to provide resistance to a desired compressive force optionally whilst maintaining a minimum diameter. In certain embodiments the inflatable brace member 1300 has a compressive strength of 420 of 1 Pa, 100 Pa, 100 kPa, 100 MPa, 100 GPa, or the like. In certain embodiments the inflatable brace member 1300 is capable of supporting a compressive force provided by the 420 clamp of 1 N, 100 N, 100 KN, 100 MN, or the like.

The inflatable brace member 1300 optionally includes a valve 1330 and optionally a hose 1340 for pumping water or other fluid into or out of the brace member 1300. In certain embodiments the hose 1340 provides fluid communication between the brace member 1300 and a fluid (e.g., air) source. In certain embodiments the brace member 1300 valve 1330 may be sealed to prevent fluid from escaping. In certain embodiments, water, gel, or the like is pumped into the brace member 1300. In certain embodiments, the brace member 1300 may be deflated by allowed fluid to exit the chamber of the brace member 1300 through the hose 1340. In certain embodiments the inflatable brace member 1300 may contain chemicals that release a gas or liquid when they react. In certain embodiments the chemicals in the brace member 1300 may be allowed to react to expand the inflatable brace member 1300 to at least a desired internal pressure.

It will be appreciated that the inflatable brace member 1300 may be inserted into the bore 115 in a deflated state and later inflated to a desired pressure. In certain embodiments the inflatable brace member 1300 and/or the optional hose 1340 may be inserted into the end 660 of the RTP body segment 270₁. In certain embodiments the inflatable brace member 1300 may be inserted into a remaining end of the RTP body segment 270₁. In certain embodiments the inflatable brace member 1300 and/or optional hose may be inserted into the bore 115 through an opening in RTP body 100 of the segment 270₁.

In certain embodiments after the inflatable brace member 1300 is filled with water when located at the desired position 615, the water may be frozen using the pipe freezer 600 illustrated in FIG. 6.

As an alternative to water a phase change material may be contained in the hollow internal chamber 1320. The phase change material may be a chemical such as sodium acetate and may be activated remotely to provide a phase change from a liquid to a solid state, optionally as part of an exothermic reaction, solidifying the contents of the hollow internal chamber 1320 in place.

The pipe freezer 600 illustrated in FIG. 6 may, via the pipe hoses 640, be filled with a hot fluid (e.g., around 100° C.) to heat RTP body 100 and thus the solidified inflatable brace member 1300. Thereby the phase change material may be heated in the RTP body 100 in order to return it to a liquid and allow extraction of the brace 1300. It will be appreciated that any means of heating the bore 115 of RTP body 100 or the brace 1300 directly could be used instead. For example the reverse phase change heating may be achieved by for instance, conduction, radiation (including microwaves), induction, or electrical resistance heating from a connection down the bore of the pipe; for induction or electrical resistance heating systems a system of electrically conductive heating wires may also be included within or around the inflatable brace member 1300 in the inflatable shell 1310 so the heat generated in the wires may transfer that heat into the phase change material and so return it to liquid form.

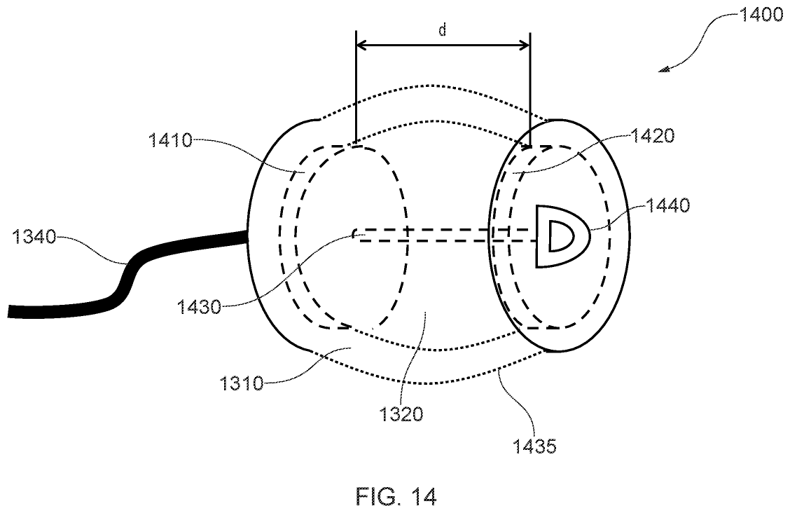

An alternative inflatable brace member 1400 is illustrated in FIG. 14. The alternative inflatable brace member 1400 may include any combination of the features of the inflatable brace member 1300 (many not shown for simplification). In addition to the features of the inflatable brace member 1300 the alternative inflatable brace member 1400 has a first end plate 1410 at a first end of the cylindrical brace member 1400 and a second end plate 1420 at a second end of the cylindrical brace member 1400. The first and second end plates 1410, 1420 are rigid or semi-rigid and separated by a distance d. The first and second end plates 1410, 1420 are attached to each other by a supporting shaft 1430 forming a cage or other system. The end plates 1410, 1420 may be formed from plastic, metal, metal alloy, composites, or any combination thereof. The supporting shaft 1430 is a supporting member located centrally a face of the first and second end plates 1410, 1420. Alternatively, there may be two or more supporting shafts 1430 forming the cage. The cage may limit the change in axial length of the brace 1400 when it is inflated. In certain embodiments the alternative inflatable brace member 1400 may expand as illustrated in FIG. 14 as the pressure of fluid in the hollow internal chamber 1320 is increased. Optionally the brace member 1400 expands only in a radial direction. The cage may also facilitate attachment of a retaining/retrieval wire and/or an electrical connection system via a connecting interface 1440. The connecting interface 1440 may include a shackle connector and a connecting eye. It will be appreciated that any brace member disclosed herein may include the connecting interface 1440.

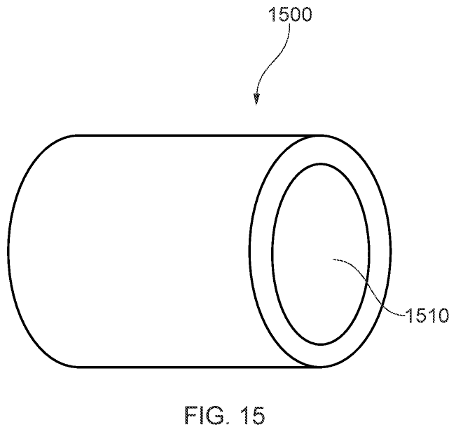

FIG. 15 illustrates another alternative brace member 1500. The brace member is a gel-formed brace member 1500. It will be appreciated that the gel-formed brace member 1500 may provide the same function, meet the same standards and be tested in the same way as the frozen brace member 410 described with respect to FIGS. 4 and 5. In certain embodiments the frozen brace member 410 may be replaced with the gel-formed brace member 1500 and the gel-formed brace member may also successfully support RTP body 100 from an external clamping force provided by the clamp 420. In certain embodiments some differences between the frozen brace member 410 and the gel-formed brace member 1500 include that they are formed differently and they are removed from the bore 115 differently.

The gel-formed brace member 1500 has a through bore 1510 that allows fluid in the bore 115 of the RTP body segment 270 to pass without completely blocking the bore 115. In certain embodiments, any brace member may include the through bore 1510. In certain embodiments, the gel-formed brace member 1500 may not include the through bore 1510.

The gel-formed brace member 1500 is hardened from a liquid gel in a mould. In certain embodiments the mould is shaped according to desired dimensions of the resulting brace member 1500. In certain embodiments the gel-formed brace member 1500 may be formed through a chemical reaction which hardens a gel and provides the gel-formed brace member 1500. In certain embodiments the chemical reaction is ultraviolet (UV)-initiated polymerisation of monomers in the gel through irradiation from a UV light source. In certain embodiments the gel-formed brace member 1500 may be formed through heating in an oven. In certain embodiments the gel-formed brace member 1500 may be formed in-situ in the bore 115. In certain embodiments the gel-formed brace member 1500 may be formed and then introduced into the bore 115 through any method including those outlined above. In certain embodiments the gel-formed brace member 1500 may be dissolvable. In certain embodiments the gel-formed brace member 1500 may be dissolvable as outlined with respect to FIG. 15. In certain embodiments the gel-formed brace member may melt at temperatures of around 100 degree centigrade or less.

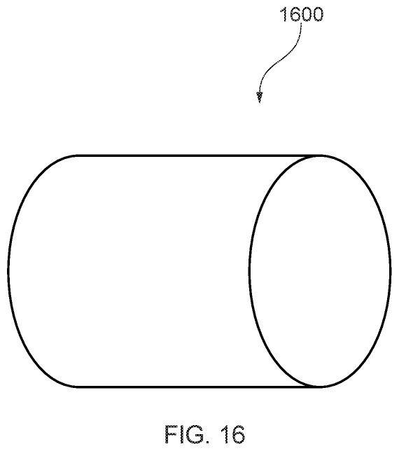

FIG. 16 illustrates another alternative brace member 1600. The brace member is a dissolvable brace member 1600. It will be appreciated that the dissolvable brace member 1600 may provide the same function, meet the same standards and be tested in the same way as the frozen brace member 410 described with respect to FIGS. 4 and 5. In certain embodiments the frozen brace member 410 may be replaced with the dissolvable brace member 1600 and the dissolvable brace member may also successfully support RTP body 100 from an external clamping force provided by the clamp 420. In certain embodiments some differences between the frozen brace member 410 and the dissolvable brace member 1600 include that they are formed differently and they are removed from the bore 115 differently. In certain embodiments the dissolvable brace member 1600 may be formed by polymerisation. In certain embodiments the dissolvable brace member 1600 may be formed by a chemical reaction. In certain embodiments the dissolvable brace member 1600 may be dissolved through chemical action. In certain embodiments the dissolvable brace member 1600 may be dissolved through electromagnetic (EM) radiation, sound waves, or the like.

Any of the above brace member embodiments may be positioned and have their position maintained remotely using at least one magnet. The brace member may contain or comprise a magnet or a ferromagnetic element which may be used initially to locate the brace element and then to hold it in position using at least one magnet or electromagnet system on the outside of the RTP pipe body.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

While certain arrangements of the inventions have been described, these arrangements have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some arrangements, the actual steps taken in the processes illustrated and/or disclosed may differ from those shown in the figures. Depending on the arrangement, certain of the steps described above may be removed, others may be added. Furthermore, the features and attributes of the specific arrangements disclosed above may be combined in different ways to form additional arrangements, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular arrangement. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may be used to refer to an amount that is within less than 10% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of supporting an end region of a reinforced thermoplastic pipe (RTP), comprising:
providing an end region of a segment of RTP body; and
as clamping elements of a clamp disposed around a covered portion of the end region are urged together to thereby support the end region at a fixed orientation, simultaneously opposing radially inwards collapse of at least one layer of the RTP body in the covered portion via a collapse resistant body disposed in a bore region of the covered portion.

2. The method as claimed in claim 1, further comprising:
the collapse resistant body comprises at least one cylindrical outer surface region and opposing radially inward collapse comprises resisting radially inwards motion of at least an inner surface of an inner layer of the RTP body via abutment of said inner surface against said cylindrical outer surface region.

3. The method as claimed in claim 1, further comprising:
subsequent to supporting the end region at a desired position via the clamping elements, securing a coupling element at a free end of the end region and securing a respective free end of a further segment of RTP body, in an end-to-end configuration with said a segment; and
subsequently at least partially removing the collapse resistant body from said a bore region.

4. The method as claimed in claim 1, further comprising:
providing the collapse resistant body by cooling a zone of the RTP body thereby freezing a region of stationary liquid located in the bore region to form a frozen brace member; and
opposing radially inward collapse via resisting radially inwards motion of at least an inner surface of an inner layer of the RTP body via abutment of said inner surface against an outer surface region of the frozen brace member.

5. The method as claimed in claim 1, further comprising:
providing the collapse resistant body by inflating a flexible hollow body via urging fluid into a chamber in the flexible hollow body to at least a predetermined internal pressure to form an inflated brace member; and
opposing radially inward collapse via resisting radially inwards motion of at least an inner surface of an inner layer of the RTP body via abutment of said inner surface against an outer surface region of the inflated brace member.

6. The method as claimed in claim 1, further comprising:
providing the collapse resistant body by hardening a gel body via urging liquid gel into a mould or inflatable shell and enabling a chemical reaction to take place to form a gel hardened brace member; and
opposing radially inward collapse via resisting radially inwards motion of at least an inner surface of an inner layer of the RTP body via abutment of said inner surface against an outer surface region of a gel hardened brace member provided via hardening a gel body via urging liquid gel into a mould and enabling a chemical reaction to take place to form the gel hardened brace member and optionally
subsequent to securing said a segment of RTP body to a further segment of RTP body via at least one coupling element, at least partially removing said collapse resistant body by dissolving the gel hardened brace member.

7. The method as claimed in claim 4, further comprising;
subsequent to securing said a segment of RTP body to a further segment of RTP body via at least one coupling element, at least partially removing said collapse resistant body by melting the frozen brace member.

8. The method as claimed in claim 5, further comprising:
subsequent to securing said a segment of RTP body to a further segment of RTP body via at least one coupling element, at least partially removing said collapse resistant body by deflating the inflated brace member.

9. The method as claimed in claim 3, wherein securing the coupling element further comprises:
terminating a precursor end region of the segment of RTP body, thereby providing the free end of the end region; and
swaging the free end into the coupling element.

10. The method as claimed in claim 1, further comprising:
prior to urging together clamping elements of the clamp, positioning the collapse resistant body in the bore region at a location associated with the covered portion and optionally
inserting the collapse resistant body into the bore region via the free end of the end region of the RTP body or via a free end of a further end region of the RTP body or via an opening in the RTP body.

11. The method as claimed in claim 10, wherein positioning the collapse body further comprises:
providing, at least one indicator for a location of the collapse resistant body in the bore region; and
subsequently detecting an indicator associated with the location of the collapse resistant body thereby determining a current location of the collapse resistant body in the bore region.

12. Apparatus for resisting collapse of a portion of reinforced thermoplastic pipe (RTP) body, comprising:
a collapse resistant body that comprises a first end and a further end disposed in a spaced apart relationship with the first end with a whole length of the collapse resistant body being at least 15 cm and a substantially cylindrical outer surface that extends over at least 70% of the whole length, the collapse resistant body providing an effective rigidity in a cylindrical region of the collapse resistant body where the outer surface is substantially cylindrical providing an effective hardness of the collapse resistant body in the cylindrical region of at least 50 on the Rockwell R scale and the collapse resistant body has a radial compression resistance at least able to withstand a radial clamping force sufficient for a resulting friction force on a test piece to resist a tension force of 70 kN (kilo newtons) applied along a longitudinal axis of the test piece.

13. The apparatus as claimed in claim 12, further comprising:
the collapse resistant body comprises a solid body or the collapse resistant body comprises a hollow tube body and optionally
the solid body or hollow tube body are provided as an integrally formed body of at least one material.

14. The apparatus as claimed in claim 13, further comprising:
the solid body or hollow tube body comprises:
an inflatable shell defining an internal chamber region; and
at least one fluid port and optionally
the inflatable shell comprises a further solid body in the internal chamber region.

15. The apparatus as claimed in claim 14, further comprising:
the solid body further comprises a first end plate at the first end and a further end plate at the further end where each of the first end plate and the further end plate are connected to at least one supporting member at respective ends of said at least one supporting member.

16. The apparatus as claimed in claim 12, further comprising:
the collapse resistant body is locatable in a bore region of RTP body, wherein at least one external dimension of the collapse resistant body is reducible through a change in an internal and/or external condition.

17. The apparatus as claimed in claim 12, further comprising:
at least one externally discoverable element that is detectible outside of RTP body when the collapse resistant body is located in a bore region of the RTP body.

18. The apparatus as claimed in claim 12, further comprising:
said radial clamping force is provided by a clamp at a covered portion of an outer surface of the test piece and a bore of the test piece is supported by the collapse resistant body located in the bore at the covered portion.

19. The apparatus as claimed in claim 18, further comprising:
the resulting friction force is provided by the radial clamping force exerted by the clamp on the outer surface of the test piece and the clamp is provided at a predetermined relative position to a loading framework as defined in ISO 3501 and optionally the clamp is provided at the predetermined relative position via abutment or mounting to the loading framework.

20. Apparatus for supporting a segment of an RTP, comprising:
a segment of RTP body comprising an internal bore, an inner layer, a reinforcement layer and an outer layer;
a clamp locatable around the outer layer; and
a collapse resistant body comprising a first end and a further end disposed in a spaced apart relationship with the first end with a whole length of the collapse resistant body being at least 15 cm and a substantially cylindrical outer surface that extends over at least 70% of the whole length, the collapse resistant body providing an effective rigidity in a cylindrical region of the collapse resistant body where the outer surface is substantially cylindrical providing an effective hardness of the collapse resistant body in the cylindrical region of at least 50 on the Rockwell R scale and the collapse resistant body has a radial compression resistance at least able to withstand a radial clamping force sufficient for a resulting friction force on a test piece to resist a tension force of 70 kN (kilo newtons) applied along a longitudinal axis of the test piece, wherein
the collapse resistant body is for opposing radially inward collapse via resisting radially inwards motion of at least an inner surface of the inner layer of the RTP body via abutment of said inner surface against an outer surface region of the collapse resistant body and optionally
said radial clamping force is provided by a clamp at a covered portion of an outer surface of the test piece and a bore of the test piece is supported by the collapse resistant body located in the bore at the covered portion and optionally
the resulting friction force is provided by the radial clamping force exerted by the clamp on the outer surface of the test piece and the clamp is provided at a predetermined relative position to a loading framework as defined in ISO 3501 and optionally the clamp is provided at the predetermined relative position via abutment or mounting to the loading framework.
